(19) United States
(12) Patent Application Publication
(10) Pub. No.: US 2025/0033008 A1
(43) Pub. Date: Jan. 30, 2025

(54) BARREL STIRRER

(71) Applicant: William Robert Brett Cagle, III, Sweetwater, TN (US)

(72) Inventor: William Robert Brett Cagle, III, Sweetwater, TN (US)

(21) Appl. No.: 18/737,260

(22) Filed: Jun. 7, 2024

Related U.S. Application Data
(60) Provisional application No. 63/515,629, filed on Jul. 26, 2023.

(51) Int. Cl. B01F 27/90; B01F 23/43; B01F 27/053; B01F 27/112; B01F 35/21; B01F 35/30; B01F 35/32; B01F 101/00

(52) U.S. Cl. CPC B01F 27/90; B01F 23/43; B01F 27/053; B01F 27/112; B01F 35/2132; B01F 35/3204; B01F 2035/351; B01F 2101/2204

(57) ABSTRACT

Various implementations disclosed herein include a barrel stirring device. The device includes a body, a motor, and a shaft. The body is configured to cover at least a portion of a head of a barrel. The body has a first side and a second side opposite and spaced apart from the first side. The motor is coupled to the body. The shaft has a longitudinal axis, a first portion, and a second portion spaced apart along the longitudinal axis from the first portion. The second portion of the shaft is couplable to a stirrer attachment. The first portion is operatively coupled to the motor such that activation of the motor causes rotation of the shaft about the longitudinal axis.

### BACKGROUND

Barrels are used to contain liquids that are undergoing chemical changes. Often the liquid in the barrels benefits from being agitated based on any number of reasons. However, barrels are sealed containers and agitation of the liquids in the barrels can be difficult.

One solution is that the barrel can be opened to access the liquid. However, some liquids deteriorate in quality in the presence of factors such as air and light. Thus, frequent and prolonged openings of the barrels can ruin some liquids. Another solution is to rotate the barrels to cause the liquid in the barrels to be agitated. However, barrels filled with liquid can be heavy and difficult to move, and the liquid in the barrel may not get thoroughly mixed by this method.

Thus, there is a need for a device to thoroughly agitate the liquid in a barrel without frequent movement of the barrel and without frequent or prolonged openings of the barrel.

### BRIEF DESCRIPTION OF DRAWINGS

Example features and implementations of the present disclosure are disclosed in the accompanying drawings. However, the present disclosure is not limited to the precise arrangements and instrumentalities shown. Similar elements in different implementations are designated using the same reference numerals.

FIG. 1 is a perspective view of a barrel stirring device, according to one implementation.

FIG. 2 is a perspective view of the barrel stirring device of FIG. 1 without the cover.

FIG. 3 is a top detail perspective view of the body of the barrel stirring device of FIG. 1.

FIG. 4 is a bottom detail perspective view of the body of the barrel stirring device of FIG. 1.

FIG. 5 is a detail perspective view of the stirrer attachment of the barrel stirring device of FIG. 1.

### DETAILED DESCRIPTION

The devices, systems, and methods disclosed herein provide for a device that can sealingly couple to the head of a barrel to stir the contents of the barrel. A hole can be bored in the head of the barrel and the stirring shaft can be inserted into the barrel. The body of the device couples to the head of the barrel to form an airtight seal around the hole so that air and light cannot enter the barrel. The device can include any number of sensors, timers, or controllers to automatically or manually start and stop the stirring shaft.

Various implementations disclosed herein include a barrel stirring device. The device includes a body, a motor, and a shaft. The body is configured to cover at least a portion of a head of a barrel. The body has a first side and a second side opposite and spaced apart from the first side. The motor is coupled to the body. The shaft has a longitudinal axis, a first portion, and a second portion spaced apart along the longitudinal axis from the first portion. The second portion of the shaft is couplable to a stirrer attachment. The first portion is operatively coupled to the motor such that activation of the motor causes rotation of the shaft about the longitudinal axis.

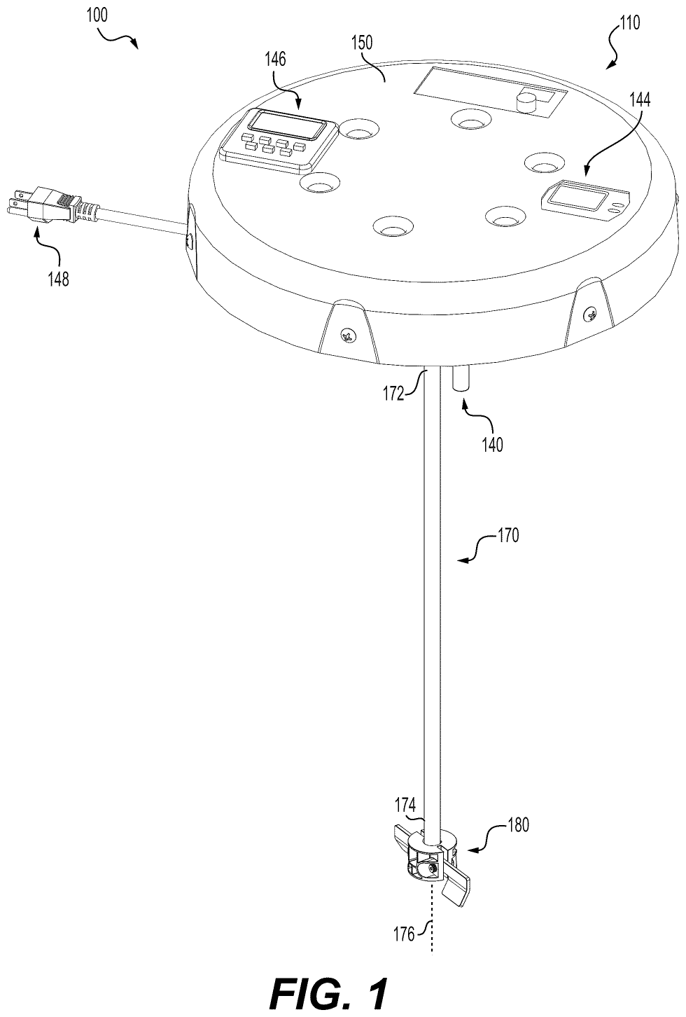

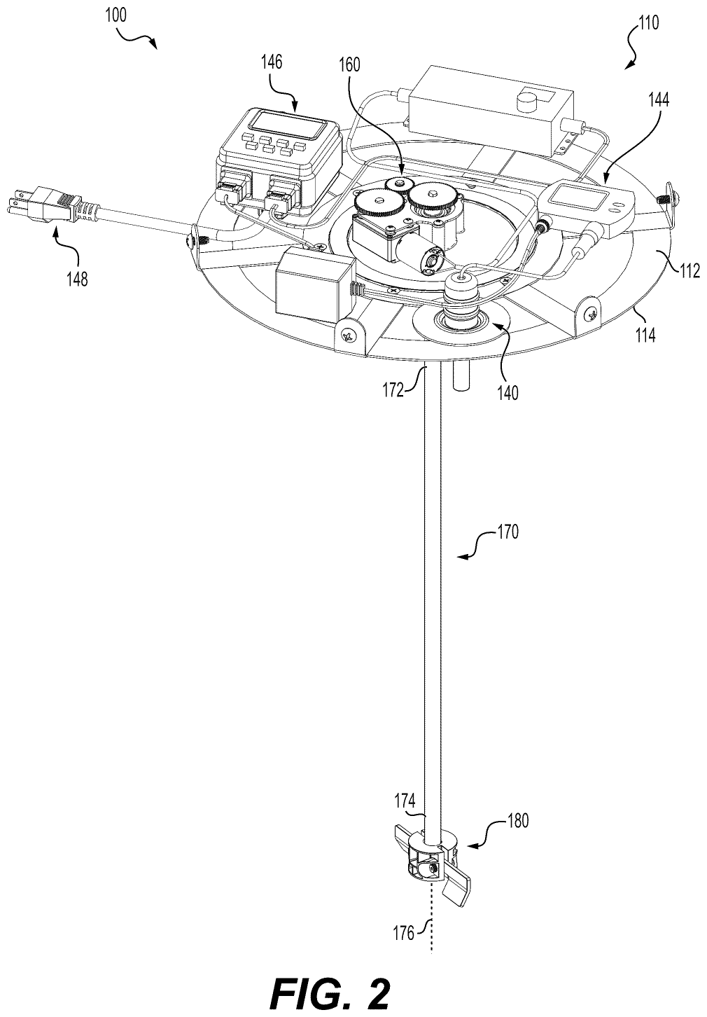

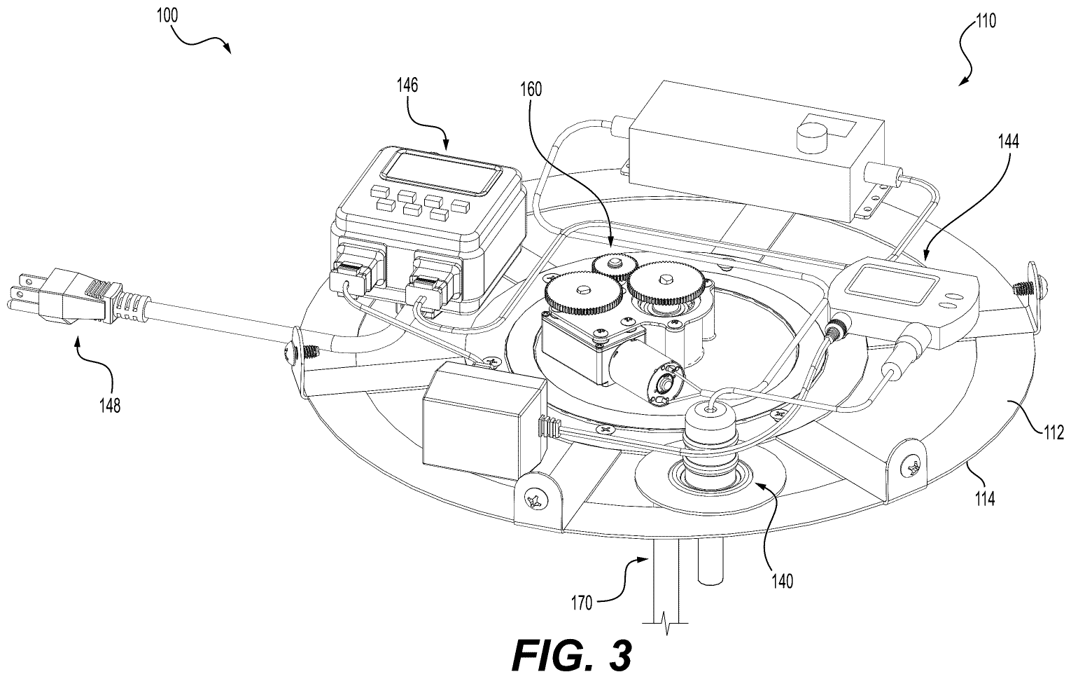

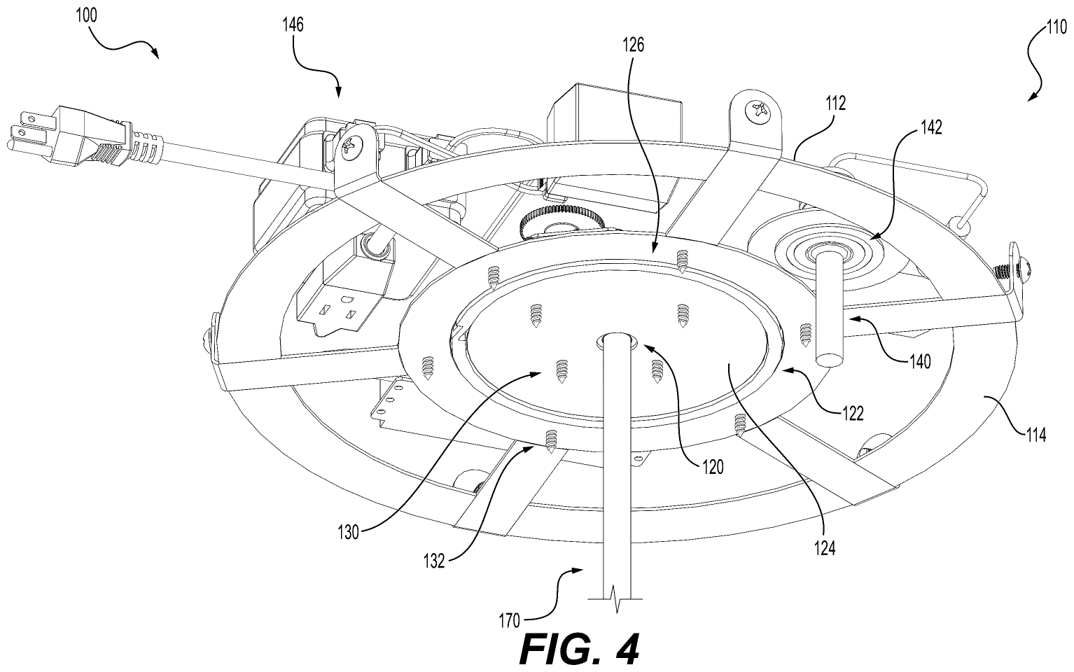

FIGS. 1-5 show a barrel stirring device 100, according to aspects of various implementations. The device 100 includes a body 110, a motor 160, and a shaft 170.

The body 110 is configured to cover at least a portion of a head of a barrel. The body 110 has a first side 112 and a second side 114 opposite and spaced apart from the first side 112. The first side 112 of the body 110 defines a central opening 120 extending to the second side 114 of the body 110. The motor 160 is coupled to the first side 112 of the body 110 such that the shaft 170 coupled to the motor 160 extends through the central opening 120. The body 110 can also include a cover 150 to protect the various features of the device 100.

The shaft 170 has a longitudinal axis 176, a first portion 172, and a second portion 174 spaced apart along the longitudinal axis 176 from the first portion 172. The second portion 174 of the shaft 170 is couplable to a stirrer attachment 180, and the first portion 172 is operatively coupled to the motor 160 such that activation of the motor 160 causes rotation of the shaft 170 about the longitudinal axis 176. The shaft 170 is oriented such that, when the body 110 is fastened to the head of the barrel such that the shaft 170 extends through the central opening 120 and into the barrel, the second portion 174 of the shaft 170 is closer to the second side 114 of the body 110 than it is to the first side 112 of the body 110.

The body 110 further includes an O-ring 122 coupled to the second side 114 of the body 110 to seal the device 100 to the head of the barrel. The O-122 ring is disposed such that the O-ring 122 encircles the central opening 120. Thus, the shaft 170 extends through an O-ring opening 124. The O-ring 122 defines a plurality of teeth 126 extending from a surface of the O-ring 122 opposite the second side 114 of the body 110. The teeth 126 are configured to engage the head of the barrel when pressure is applied to the body 110 of the device 100 to couple it to the barrel. The engagement of the teeth 126 ensure that the O-ring 122 sealingly couples to the head of the barrel.

The body 110 further defines a first ring of fastener openings 130 and a second ring of fastener openings 132. The fastener openings of the first ring of fastener openings 130 and the second ring of fastener openings 132 are configured to accept fasteners therethrough that are able to fasten the device 100 to the head of the barrel. The plurality of fastener openings in each ring of fastener openings 130, 132 are circumferentially spaced apart from each other around the longitudinal axis 176 of the shaft 170. The first row of fastener openings 130 is concentrically disposed within the second ring of fastener openings 132, and the O-ring 122 is concentrically disposed between the first ring of fastener openings 130 and the second ring of fastener openings 132. Thus, when fasteners are disposed through each of the fastener openings of the first ring of fastener openings 130 and the second ring of fastener openings 132 to fasten the body 110 to the head of the barrel, the fasteners in the first ring of fastener openings 130 and the second ring of fastener openings 132 apply force to the radially inner and radially outer sides of the O-ring 122 wall to drive the teeth 126 of the O-ring 122 into the wooden head of the barrel.

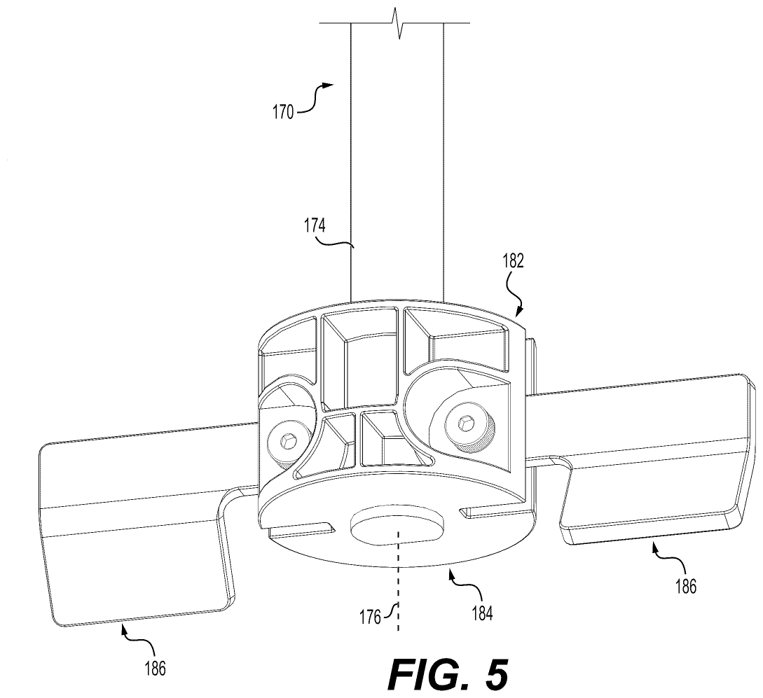

The second portion 174 of the shaft 170 is couplable to the stirrer attachment 180, either permanently or interchangeably. As seen in FIG. 5, the stirrer attachment 180 is interchangeably or removably coupled to the second portion 174 of the shaft 170. The stirrer attachment 180 includes an attachment body 182 and two blades 186. The attachment body 182 defines an attachment opening 184 that receives the second portion 174 of the shaft 170. The blades 186 are circumferentially spaced apart from each other around the attachment opening 184. The blades 186 are hingably coupled to the attachment body 182 such that the distal ends of the blades 186 can rotate toward the first portion 172 of the shaft 170. Thus, when the stirrer attachment 180 and the second portion 174 of the shaft 170 are inserted into an opening in the head of a barrel, the blades 186 can fold toward the first portion 172 of the shaft 170 such that the stirrer attachment 180 can better fit through the relatively tight opening in the head of the barrel. Once the device 100 is secured to the head of the barrel, as discussed above, rotation of the motor 160 causes rotation of the shaft 170 and stirrer attachment 180, and the centrifugal forces of the rotation cause the blades 186 of the stirrer attachment 180 to extend outwardly toward a position that is perpendicular to the longitudinal axis 176 of the shaft 170. The blades 186 of the stirrer attachment 180 shown in FIG. 5 includes charred wood, but in some implementations, the entire stirrer attachment includes charred wood, a different portion of the stirrer attachment includes charred wood, or no portions of the stirrer attachment includes charred wood.

The body 110 of the device 100 further includes a probe 140. The probe 140 extends from the second side 114 of the body 110. In use, separate openings are formed in the head of the barrel for the shaft 170 and the probe 140 for the device 100 shown in FIGS. 1-4. However, in some implementations, the probe may be disposed close enough to the shaft such that the probe and shaft can be inserted through the same opening formed in the head of the barrel. In such implementations, the probe is disposed within the O-ring opening. For the device 100 shown in FIGS. 1-5, the probe 140 includes a separate probe O-ring 142 to seal the body 110 of the device 100 around the probe 140 to the head of the barrel to form an air tight seal.

The probe 140 can include one or several measurement instruments to determine factors about the contents of the barrel. For example, the probe 140 can include a ppm reader to determine to the phenol content and/or the ester content of the contents of the barrel. The probe 140 can include a pH reader to determine to the acidity or alkalinity of the contents of the barrel. In some implementations, the probe 140 can include any other means for measuring a factor of the contents of the barrel.

The body 110 of the device 100 can further include a timer 144 to determine the stir time or the run time of the motor 160. The body 110 also can include a controller 146 to receive inputs from the user. The device 100 includes a power cable 148 to couple the electronic components of the device 100 to a power source.

In some implementations, the barrel stirring device is a first device of a system, ad the system further includes at least a second barrel stirring device. The first device and the second device are in electronic communication with each other. Each device includes a Bluetooth transmitter and receiver, and the devices are in electronic communication with each other through the Bluetooth transmitter and receiver. In some implementations, the system further includes a controller and the controller is in electronic communication with each of the devices. In any of these implementations, the devices are able to communicate with each other and/or the controller to share information and give and receive commands.

A number of example implementations are provided herein. However, it is understood that various modifications can be made without departing from the spirit and scope of the disclosure herein. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. Although the terms “comprising” and “including” have been used herein to describe various implementations, the terms “consisting essentially of” and “consisting of” can be used in place of “comprising” and “including” to provide for more specific implementations and are also disclosed.

Disclosed are materials, systems, devices, methods, compositions, and components that can be used for, can be used in conjunction with, can be used in preparation for, or are products of the disclosed methods, systems, and devices. These and other components are disclosed herein, and it is understood that when combinations, subsets, interactions, groups, etc. of these components are disclosed that while specific reference of each various individual and collective combinations and permutations of these components may not be explicitly disclosed, each is specifically contemplated and described herein. For example, if a device is disclosed and discussed each and every combination and permutation of the device are disclosed herein, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed systems or devices. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

What is claimed is:

1. A barrel stirring device, the device comprising:
a body configured to cover at least a portion of a head of a barrel, the body having a first side and a second side opposite and spaced apart from the first side;
a motor coupled to the body; and
a shaft having a longitudinal axis, a first portion, and a second portion spaced apart along the longitudinal axis from the first portion, wherein the second portion of the shaft is couplable to a stirrer attachment, wherein the first portion is operatively coupled to the motor such that activation of the motor causes rotation of the shaft about the longitudinal axis.

2. The device of claim 1, wherein the stirrer attachment is permanently attached to the second portion of the shaft.

3. The device of claim 1, further comprising the stirrer attachment, wherein the stirrer attachment includes one or more blades extending perpendicularly relative to the longitudinal axis.

4. The device of claim 3, wherein the one or more blades are pivotable relative to the longitudinal axis.

5. The device of claim 1, further comprising the stirrer attachment, wherein the stirrer attachment comprises charred wood.

6. The device of claim 1, wherein the first side of the body defines a central opening extending to the second side of the body, wherein the motor is coupled to the first side of the body, wherein the shaft extends through the central opening such that the second portion of the shaft is closer to the second side of the body than it is to the first side of the body.

7. The device of claim 1, wherein the first side of the body defines one or more fastener openings extending to the second side of the body.

8. The device of claim 7, wherein the one or more fastener openings includes a plurality of fastener openings circumferentially spaced apart from each other around the longitudinal axis.

9. The device of claim 1, further comprising an O-ring coupled to the second side of the body.

10. The device of claim 9, wherein the O-ring defines a plurality of teeth extending from a surface opposite the second side of the body.

11. The device of claim 9, wherein the shaft extends through an O-ring opening.

12. The device of claim 8, further comprising an O-ring coupled to the second side of the body, wherein the plurality of fastener openings circumferentially spaced apart from each other around the longitudinal axis is a first ring of fastener openings, wherein the body further defines a second ring of fastener openings including a second plurality of fastener openings circumferentially spaced apart from each other around the longitudinal axis, wherein the first row of fastener openings is concentrically disposed within the second ring of fastener openings, wherein the O-ring is concentrically disposed between the first ring of fastener openings and the second ring of fastener openings.

13. The device of claim 1, further comprising a probe extending away from the second side of the body.

14. The device of claim 13, further comprising an O-ring coupled to the second side of the body, wherein the probe is disposed within an O-ring opening.

15. The device of claim 13, wherein the probe comprises a ppm reader to determine to phenol content.

16. The device of claim 13, wherein the probe comprises a ppm reader determine an ester content.

17. The device of claim 13, wherein the probe comprises a pH reader.

18. The device of claim 1, further comprising a timer.

19. A system comprising two or more devices of claim 1.

20. The system of claim 19, wherein the two or more devices are in electronic communication with each other.

21. The system of claim 20, further comprising a Bluetooth transmitter and receiver, wherein the two or more devices are in electronic communication with each other via Bluetooth.

22. The system of claim 20, further comprising a controller for controlling the two or more devices.
